(19) United States
(12) Patent Application Publication
(10) Pub. No.: US 2011/0239659 A1
(43) Pub. Date: Oct. 6, 2011

(54) COOLING FOR HYBRID ELECTRIC VEHICLE

(75) Inventor: David Lior, Herzliya (IL)

(73) Assignee: ETV ENERGY LTD., Herzliya (IL)

(21) Appl. No.: 13/131,401

(22) PCT Filed: Aug. 30, 2009
(86) PCT No.: PCT/IB09/53781

§ 371 Date: Jun. 22, 2011

(30) Foreign Application Priority Data
Dec. 15, 2008 (US) 61/122468
Mar. 18, 2009 (GB) 0904632.7

(51) Int. Cl. B60H 1/32; F02C 6/20

(52) U.S. Cl. 60/783; 60/784; 903/906; 903/907

(57) ABSTRACT

Hybrid gas-turbine electric vehicles and methods for operating hybrid gas-turbine electric vehicles are provided that make use of the gas-turbine for efficiently providing cooling for the vehicle.

### RELATED APPLICATIONS

The present application gains priority from U.S. Provisional Patent Application No. 61/122,468 filed 15 Dec. 2008 and from UK Patent Application No. 0904632.7 filed 18 Mar. 2009.

### FIELD AND BACKGROUND OF THE INVENTION

The present invention, in some embodiments, relates to the field of cooling and more particularly, but not exclusively, to cooling in hybrid gas-turbine electric vehicles.

Wheeled motor vehicles are an inseparable part of a modern industrial society, providing cheap, simple and efficient transport of people and goods. Such societies would function with great difficulty without automobiles, trucks and buses which allow for efficient concentration and distribution of industrial, commercial and residential loci.

The ubiquity of motor vehicles is in a large part a result of the existence of the internal combustion engine (ICE), primarily Otto-cycle and Diesel-cycle engines powered by cheap and readily available fossil fuel. ICEs have a reasonable power to weight ratio and provide a wide range of power on demand. However, ICEs are relatively inefficient and continuously produce harmful emissions even when idling.

As more vehicles are available, the effects of harmful emissions produced by ICEs (especially in crowded urban areas) increase, leading to a need to reduce the emissions produced by motor vehicles. Additionally, the possible shortage and/or increase in the price of fossil fuels lead to a parallel need to reduce fossil fuel consumption by motor vehicles.

An alternative to ICE-powered vehicles is all-electric vehicles. All-electric vehicles have one or more electric motors powered with electric power stored in on-board battery packs. Electric motors produce no harmful emissions during operation. The battery packs are charged from the electric grid, while the vehicle is parked, with electric power produced in a remote central electric power plant. Efficient, cheap, renewable or less-polluting central power plants may be used to produce the electric power at the central power plant. All-electric vehicles have a limited range, especially when driving at high speeds or with heavy loads. Additionally, the limited number of charge/discharge cycles available to any battery means that vehicle battery packs are eventually spent and then must be replaced. As a result, the lifetime cost of operating the vehicle may be prohibitive.

In order to overcome some of the disadvantages of ICE-powered and of all-electric vehicles, hybrid vehicles have been developed. Such vehicles include an ICE, one or more electric motors, an electric generator and battery packs to store electric power. Hybrid vehicles produce fewer emissions and are more fuel-efficient than ICE-powered vehicles and are not limited in range like all-electric vehicles. There are different types of hybrid vehicles each having advantages and disadvantages.

In some hybrid vehicles, the ICE primarily drives the vehicle while the electric motors are configured to provide extra driving power when needed, allowing the ICE to be smaller than otherwise. Some such hybrid vehicles are configured to optionally drive only with the electric motors, for example from a complete stop allowing the ICE to be turned off when not needed to reduce emissions.

In such vehicles, the batteries for providing power to the electric motors are typically charged with electric power generated by the on-board generator driven by the ICE and/or electric power from the power grid while parking.

In some hybrid vehicles the electric motors primarily drive the vehicle while the ICE acts as an on-board charger to generate electric power to store in the battery pack and/or to directly power the electric motors. In such vehicles, the battery packs may be optionally charged with electric power from the power grid while parking.

Often, hybrid vehicles are provided with regenerative braking units that brake the vehicle by converting kinetic energy to electric power that is subsequently stored in the battery packs. The battery pack acts as an energy-sink, storing otherwise wasted energy to be used by the electrical motors to drive the vehicle when extra power is needed and consequently to reduce the use of fuel by the ICE and increase the range of the vehicle.

Increasingly, vehicular air-conditioning, especially cooling, is an important accessory in every vehicle, both for passenger comfort and for safety. Drivers in non-air-conditioned vehicles are more tired and more aggressive than air-conditioned counterparts, and are therefore prone to mistakes and errors of judgment. However, an air conditioning system is the largest auxiliary load on a vehicle, using an amount of power that significantly affects vehicle performance. For example, in one study it was shown that air-conditioning reduces the fuel-economy of efficient ICE-powered vehicles by about 50% and the range of all-electric vehicles by about 36% (Farrington R and Rugh J, “Impact of Vehicle Air-Conditioning on Fuel Economy, Tailpipe Emissions and Electric Vehicle Range” presented at the Earth Technologies Forum, Oct. 31, 2000).

The fact that the air conditioning system uses a significant amount of power means that a given vehicle must have a larger ICE to power the air conditioning unit to retain a desired level of performance. Similarly, this means that a given vehicle must have larger and heavier battery packs to power an air-conditioning unit to retain a desired level of performance.

An additional problem for air-conditioned electric vehicles relates to battery lifetime. As noted above, a battery has a limited number of charge/recharge cycles. When a significant amount of battery power is used for air-conditioning, battery lifetime is reduced, increasing vehicle operating costs.

It would be highly desirable to have an air-conditioned motor vehicle devoid of at least some of the limitations of air-conditioned motor vehicles known in the art.

### SUMMARY OF THE INVENTION

Aspects of the invention relate to cooling in hybrid gas-turbine electric vehicles that in some embodiments have advantages over known methods and vehicles. Specifically some embodiments of the invention relate to hybrid gas-turbine electric vehicles where, when the gas-turbine is not in an active state powering a generator, the gas-turbine is used as an air-cycle machine. In some embodiments, the gas-turbine is also used to provide heat for driving an absorption chiller.

According to an aspect of some embodiments of the invention there is provided a method of operating a hybrid gas-turbine vehicle comprising: a) in a first operation mode, providing electric power to an electric drive motor of the vehicle (to drive the vehicle) with electric power generated by an electric generator powered by a gas-turbine operating in an active state; and b) switching to a second operation mode, wherein the gas-turbine is in a passive state operating as an air-cycle machine to provide cooling for the vehicle. In some embodiments, the electric power to drive the vehicle is provided to the electric drive motor from a power storage unit. In some embodiments, the electric power to operate the gas-turbine as an air-cycle machine is provided from a power storage unit.

In some embodiments, in the first operation mode the method further comprises directing exhaust from the gas-turbine to drive an absorption chiller to provide cooling for the vehicle.

In some embodiments, in the second operation mode the method further comprises directing exhaust from the gas-turbine to drive an absorption chiller to provide cooling for the vehicle, in some embodiments in addition to the cooling provided by the gas-turbine operating as an air-cycle machine.

In some embodiments, in the first operation mode the method further comprises operating an air-conditioner to provide cooling for the vehicle

In some embodiments, in the second operation mode the method further comprises operating an air-conditioner to provide cooling for the vehicle

In some embodiments, the cooling provided by the gas-turbine operating as an air-cycle machine, by the absorption chiller and/or by the air conditioner is used to cool a passenger compartment of the vehicle. In some embodiments, the cooling provided by the gas-turbine operating as an air-cycle machine, by the absorption chiller and/or by the air conditioner is used to cool a non-passenger cargo compartment of the vehicle. In some embodiments, the cooling provided by the gas-turbine operating as an air-cycle machine, by the absorption chiller and/or by the air conditioner is used to cool a power storage unit, for example a battery pack, of the vehicle.

According to an aspect of some embodiments of the invention there is also provided a gas-turbine hybrid electric vehicle, comprising:
a) an electrical generator for generating electric power; and
b) a gas-turbine, including an air intake, a combustor, a compressor and a turbine, functionally associated with the generator and configured to operate in at least two states:
   i. an active state (where fuel is burned in the combustor and the released energy converted to mechanical energy by expansion through the turbine) wherein the gas-turbine powers the generator to generate electric power; and
   ii. a passive state where the gas-turbine functions as an air-cycle machine to provide cooling for the vehicle.

In some embodiments, the gas-turbine is configured for operation according to a Brayton cycle. In some embodiments, the gas-turbine is configured for operation according to an inverse Brayton cycle. In some embodiments, the gas-turbine is a multipressure mode gas-turbine configured for operation according to an inverse Brayton cycle and according to a Brayton cycle.

In some embodiments, the configuration of the gas-turbine to operate in the active state or in the passive state includes a valve.

In some embodiments, the gas-turbine further comprises an air-cycle machine intake valve and wherein:
the air-cycle machine intake valve is configured to direct exhaust from the combustor to the turbine in the active state; and
the air-cycle machine intake valve is configured to direct air from the air intake to the turbine while bypassing the combustor in the passive state.

In some embodiments, the gas-turbine comprises a primary heat-exchanger to recover heat from exhaust gas exiting the compressor to preheat air entering the combustor in the active state

In some embodiments, the gas-turbine further comprises an air-cycle machine heat-exchanger, configured to cool a cooling fluid when the gas-turbine operates as an air-cycle machine in the passive state and an air-cycle machine heat-exchanger diverter valve, wherein:
the air-cycle machine heat-exchanger diverter valve is configured to direct gas exiting the turbine to pass through the primary heat-exchanger in the active state; and
the air-cycle machine heat-exchanger diverter valve is configured to direct gas exiting the turbine to bypass the primary heat-exchanger and to pass through the air-cycle machine heat-exchanger in the passive state, thereby allowing the cooling of the cooling fluid.

In some embodiments, a gas-turbine further comprises an air-cycle machine motor, configured for driving the gas-turbine to operate as an air-cycle machine in the passive state.

In some embodiments, the generator is configured to drive the gas-turbine to function as an air-cycle machine in the passive state.

In some embodiments, the vehicle further comprises at least one rechargeable power storage unit for storing electric power generated by the electric generator and for releasing stored power as electric power to optionally power the gas-turbine in the passive state.

In some embodiments, the vehicle further comprises an absorption chiller for providing cooling for the vehicle. In some embodiments, the absorption chiller is configured to be driven by exhaust heat produced by the gas-turbine. For example, in some embodiments the vehicle comprises a valve that optionally directs at least a portion of the exhaust of the gas-turbine to drive the absorption chiller. In some embodiments, the absorption chiller is configured to be driven by exhaust heat produced by the gas-turbine when operated in the active state. In some embodiments, the absorption chiller is configured to be driven by exhaust heat produced by the gas-turbine when operated as an air-cycle machine in the passive state. In some embodiments, the gas-turbine further comprises a variable chiller diverter valve, configured to regulate the amount of exhaust gas exiting the compressor that is directed to drive the absorption chiller.

In some embodiments, a vehicle of the invention is devoid of an electric-powered air-conditioner for providing cooling for the vehicle.

In some embodiments, a vehicle of the invention comprises an electric-powered air-conditioner for providing cooling for the vehicle. In some embodiments, the air-conditioner is operable when the gas-turbine is in the active state. In some embodiments, the air-conditioner is operable when the gas-turbine is in the inactive state.

In some embodiments, the vehicle is configured to direct the cooling provided by the gas-turbine in the passive state to a power storage unit of the vehicle. In some embodiments, the vehicle is configured to direct the cooling provided by the gas-turbine in the passive state to a passenger compartment of the vehicle. In some embodiments, the vehicle is configured to direct the cooling provided by the gas-turbine in the passive state to a non-passenger cargo compartment of the vehicle.

Unless otherwise defined, all technical and scientific terms used herein have the same meaning as commonly understood by one of ordinary skill in the art to which this invention pertains. In case of conflict, the patent specification, including definitions, will control.

As used herein, the terms “comprising”, “including”, “having” and grammatical variants thereof are to be taken as specifying the stated features, integers, steps or components but do not preclude the addition of one or more additional features, integers, steps, components or groups thereof. These terms encompass the terms “consisting of” and “consisting essentially of”.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the described composition, device or method.

As used herein, the indefinite articles “a” and “an” mean “at least one” or “one or more” unless the context clearly dictates otherwise.

### BRIEF DESCRIPTION OF THE FIGURES

Some embodiments of the invention are herein described, by way of example only, with reference to the accompanying figures. The description, together with the figures, makes apparent how embodiments of the invention may be practiced to a person having ordinary skill in the art. The figures are for the purpose of illustrative discussion of embodiments of the invention and no attempt is made to show structural details of an embodiment in more detail than is necessary for a fundamental understanding of the invention. For the sake of clarity, some objects depicted in the figures are not to scale.

In the Figures:

FIGS. 1A-1D are schematic depictions of an embodiment of a vehicle including an inverse Brayton cycle gas-turbine operating operable as an air-cycle machine; and

FIGS. 2A-2B are schematic depictions of an embodiment of a vehicle including a Brayton cycle gas-turbine operating operable as an air-cycle machine.

### DESCRIPTION OF SOME EMBODIMENTS OF THE INVENTION

Aspects of the invention relate to cooling in hybrid gas-turbine electric vehicles. Aspects of the invention relate to hybrid gas-turbine electric vehicles including a cooling system that in some embodiments comprises an absorption chiller. Aspects of the invention relate to hybrid gas-turbine electric vehicles including a cooling system that in some embodiments comprises an air-cycle machine. In some embodiments, a gas-turbine of a hybrid gas-turbine electric vehicle is used as an air-cycle machine to provide cooling when the gas-turbine is not active for powering an electric generator. In some embodiments, exhaust heat produced by the gas-turbine operating as an air-cycle machine is used to drive an absorption chiller.

The principles, uses and implementations of the teachings of the invention may be better understood with reference to the accompanying description and figures. Upon perusal of the description and figures present herein, one skilled in the art is able to implement the teachings of the invention without undue effort or experimentation. In the figures, like reference numerals refer to like parts throughout.

Before explaining at least one embodiment of the invention in detail, it is to be understood that the invention is not limited in its application to the details set forth herein. The invention can be implemented with other embodiments and can be practiced or carried out in various ways. It is also understood that the phraseology and terminology employed herein is for descriptive purpose and should not be regarded as limiting.

Gas-turbines are known for being lightweight, efficient, reliable and requiring little maintenance. However, gas-turbines are not well known for use with ground vehicles such as cars and trucks for a number of reasons.

A first reason is that a given gas-turbine is designed to generate a specific power output at highest efficiency. Generation of power output that is greater or lesser than the designed power output is significantly less efficient. Vehicles have highly variable power demands, requiring more power for rapid acceleration or climbing hills, requiring less power when cruising and virtually no power when stopped.

A second reason is that the power requirements for ground vehicles are low compared to the power gas-turbines efficiently produce. Although large gas-turbines are relatively efficient, the efficiency of a gas-turbine dramatically decreases with smaller size (e.g., less than 300 kW) for various reasons including leakage of heated gas from the combustor around the periphery of the turbine, leakage which is more significant with smaller turbine size.

A third reason is “turbine lag”: it takes a noticeably long time for a given gas-turbine to speed-up and stabilize to produce more power, e.g., for acceleration.

A fourth reason is that the lifetime of gas-turbines is severely limited by startup/shutdown events. Unlike an ICE, it is not practical to shut down a gas-turbine when idling.

Capstone Turbine Corporation (Chatsworth, Calif., USA) has proposed a hybrid gas-turbine electric bus, described in the introduction of U.S. Pat. No. 6,526,757. Such a bus includes an electric drive motor, a relatively small and light battery pack which supplies power to the drive motor and a gas-turbine functionally associated with a generator. The gas-turbine is the primary source of power for the bus and is configured to power the drive motor, to power auxiliary loads and to charge the battery pack. The gas-turbine is selected having a designed power output that is the average power required by the bus. During operation, the gas-turbine is continuously operated at the designed power output to having greatest efficiency. When the bus is stopped, the electric power produced by the gas-turbine is used to charge the battery pack and power the auxiliary loads. The battery pack supplies additional electric power when the bus requires a greater amount of power, for example for acceleration. A disadvantage of such a method of operation is that the gas-turbine continuously operates, producing harmful emissions.

It would be advantageous to operate a hybrid gas-turbine electric vehicle where at least part of the time the gas-turbine is in an active state operating as close as possible to the designed power output, combusting fuel to power an electric generator and at least part of the time the gas-turbine is in a passive state and not combusting fuel to reduce emissions, where electric power for operating the vehicle is drawn from a power storage unit such as a battery pack. However, a major challenge in operating the vehicle is cooling. As discussed in the introduction, air conditioning requires a significant amount of power that severely reduces vehicle performance.

When the gas-turbine of a gas-turbine electric hybrid vehicle is in an active state, the gas-turbine can be configured to be sufficiently powerful to produce enough electric power for operating an air-conditioning unit. A disadvantage of such a configuration is that the gas-turbine must produce more power to power the air-conditioner and therefore produces more emissions, and produces excess power when the air-conditioning unit is not activated. Further, when the gas-turbine is in a passive state and not an active state, the power to power the air-conditioner is drawn from a power storage unit severely reduces vehicle performance.

An aspect of some embodiments of the invention relates to hybrid gas-turbine electric vehicles and methods of operating hybrid gas-turbine electric vehicles that overcome some of the problems associated with cooling as discussed above.

Some embodiments of the invention relate to an entirely different concept of operation of a hybrid gas-turbine electric vehicle at least two modes.

In the first mode, the gas-turbine of the vehicle is in an active state (fuel is combusted in the combustor) and powers a generator to provide electric power for the vehicle, for example the drive motors and auxiliary loads. Extra power may be stored in chargeable power storage unit such as a battery pack. In some embodiments, cooling is provided by an absorption chiller driven by otherwise wasted heat from gas-turbine exhaust.

In the second mode, the gas-turbine is in a passive state (no fuel is combusted in the combustor) and electric power for the vehicle is provided, for example, by the power storage unit. Such a second mode allows emission-free operation of the vehicle, useful, for example, for operation in urban areas. In some embodiments, use of such a mode allows the vehicle to utilize cheap and relatively environmentally friendly grid electric power. In some embodiments, use of such a mode allows the vehicle to utilize cheap kinetic energy recovered with the use of a regenerative braking system.

In some embodiments, in the second mode, cooling is provided by using the gas-turbine as an air-cycle machine. As discussed below, in some embodiments the coefficient of performance of the gas-turbine operating as an air-cycle machine is approximately 1.

In some such embodiments, the hot exhaust generated by the air-cycle machine is used to drive an absorption chiller to provide additional cooling capacity. As discussed below, in embodiments the coefficient of performance of a cooling unit using a gas-turbine as an air-cycle machine together with an absorption chiller is at least 3.

In some embodiments, the use of a passive gas-turbine as an air-cycle machine allows implementation of efficient vehicular cooling having one or more advantages.

Generally, a gas-turbine in the active state generates more than enough waste heat to drive an absorption chiller but also generates more than enough electric power to power an air conditioner. However, an air conditioner uses electric power that is otherwise available to power the drive motors, for example for sudden acceleration or for high speed cruising. Thus in some embodiments the teachings of the invention improve the performance of a hybrid gas-turbine electric vehicle.

In some embodiments, the use of the gas-turbine as an air-cycle machine, especially together with an absorption chiller provides a practical source of cooling as an alternative to a standard air conditioner.

In some embodiments, use of an absorption chiller instead of an air conditioner provides a more robust, simpler to maintain and/or more silent cooling system.

In some embodiments, use of waste heat for generating cooling reduces the power requirements for cooling, giving the vehicle improved performance, for example increased range from the power storage unit and greater instantaneous performance.

In some embodiments, greater fuel efficiency is achieved. In some embodiments, greater vehicular range is achieved.

### Method of Operating a Hybrid Gas-Turbine Electric Vehicle

According to an aspect of some embodiments of the invention there is provided a method of operating a hybrid gas-turbine vehicle comprising: a) in a first operation mode, providing electric power to an electric drive motor of the vehicle to drive the vehicle with electric power generated by an electric generator powered by a gas-turbine operating in an active state; and b) switching to a second operation mode, wherein the gas-turbine is in a passive state operating as an air-cycle machine to provide cooling for the vehicle. In some embodiments, electric power to drive the vehicle is provided to the electric motor from a power storage unit. In some embodiments, electric power to power the gas-turbine as an air-cycle machine is provided from a power storage unit.

Any suitable gas-turbine may be used in implementing the teachings of the invention, including Brayton cycle, inverse Brayton cycle and multi-pressure gas-turbines such as described in U.S. Pat. No. 6,526,757 or in copending provisional patent application U.S. 61/116,394 of the Inventor.

In some embodiments, in the first operation mode, the method further comprises directing exhaust from the gas-turbine to drive an absorption chiller to provide cooling for the vehicle.

In some embodiments, in the second operation mode the method further comprises directing exhaust from the gas-turbine to drive an absorption chiller to provide cooling for the vehicle, in some embodiments in addition to the cooling provided by the gas-turbine operating as an air-cycle machine.

In some embodiments, in the first operation mode the method further comprises operating an air-conditioner to provide cooling for the vehicle

In some embodiments, in the second operation mode the method further comprises operating an air-conditioner to provide cooling for the vehicle

In some embodiments, the cooling provided by the gas-turbine operating as an air-cycle machine, by the absorption chiller and/or by the air conditioner is used to cool a passenger compartment of the vehicle. In some embodiments, the cooling provided by the gas-turbine operating as an air-cycle machine, by the absorption chiller and/or by the air conditioner is used to cool a non-passenger cargo compartment of the vehicle.

Although the method of operating a hybrid gas-turbine electric vehicle described herein may be implemented using any suitable hybrid gas-turbine electric vehicle, in some embodiments it is preferred to implement the method using a hybrid gas-turbine electric vehicle of the invention.

### Hybrid Gas-Turbine Electric Vehicle

According to an aspect of some embodiments of the invention there is provided a hybrid gas-turbine electric vehicle.

According to an aspect of some embodiments of the invention there is provided a gas-turbine hybrid electric vehicle, comprising:
a) an electrical generator (a machine that converts mechanical energy to electrical energy) for generating electric power; and
b) a gas-turbine, including an air intake, a combustor, a compressor and a turbine, functionally associated with the generator and configured to operate in at least two states:
   i. an active state, where fuel is burned in the combustor and the released energy converted to mechanical energy by expansion through the turbine, wherein the gas-turbine powers the generator to generate electric power; and
   ii. a passive state where the gas-turbine functions as an air-cycle machine to provide cooling for the vehicle.

Generally, a vehicle of the invention is any suitable type of vehicle. A vehicle of the invention is preferably a wheeled-vehicle such as an automobile, a minibus (having a capacity of up to ten seated passengers and a driver), a bus, a light truck (up to about 3500 kilogram gross vehicular mass, including pickups, SUVs, vans and minivans) or a heavy truck (from about 3500 kilogram gross vehicular mass). That said, in some embodiments, a vehicle of the invention is a track-riding vehicle (e.g., a train or tram) or a track-laying vehicle.

The gas-turbine may be any suitable gas-turbine. In some embodiments, the gas-turbine is configured for operation according to a Brayton cycle. In some embodiments, the gas-turbine is configured for operation according to an inverse Brayton cycle. In some embodiments, the gas-turbine is a multipressure mode gas-turbine configured for operation according to an inverse Brayton cycle and according to a Brayton cycle, for example as described in U.S. Pat. No. 6,526,757 or in copending provisional patent application U.S. 61/116,394 of the Inventor.

In some embodiments, the configuration of the gas-turbine to operate in the active state or in the passive state includes a valve.

In some embodiments, the gas-turbine further comprises an air-cycle machine intake valve and wherein: the air-cycle machine intake valve is configured to direct exhaust from the combustor to the turbine in the active state; and the air-cycle machine valve is configured to direct air from the air intake to the turbine while bypassing the combustor in the passive state. An air-cycle machine intake valve may be physically implemented using any suitable valve or combination of valves. In some embodiments, the air-cycle machine intake valve is implemented with one or more valve members held in one more valve bodies.

In some embodiments, the gas-turbine comprises a primary heat-exchanger to recover heat from exhaust gas exiting the compressor to preheat air entering the combustor in the active state. In such embodiments, any suitable type of primary heat-exchanger may be used including a recuperator or a regenerator, especially a rotary regenerator.

In some embodiments, the gas-turbine further comprises an air-cycle machine heat-exchanger, configured to cool a cooling fluid when the gas-turbine operates as an air-cycle machine and an air-cycle machine heat-exchanger diverter valve, wherein: the air-cycle machine heat-exchanger diverter valve is configured to direct gas exiting the turbine to pass through the primary heat-exchanger in the active state; and the air-cycle machine heat-exchanger diverter valve is configured to direct gas exiting the turbine to bypass the primary heat-exchanger and to pass through the air-cycle machine heat-exchanger, thereby allowing the cooling of the cooling fluid in the passive state. An air-cycle machine heat-exchanger diverter valve may be physically implemented using any suitable valve or combination of valves. In some embodiments, the air-cycle machine intake valve is implemented with one or more valve members held in one more valve bodies.

In some embodiments, a gas-turbine further comprises an air-cycle machine motor, configured for driving the gas-turbine to operate as an air-cycle machine in the passive state.

In some embodiments, the generator is configured to drive the gas-turbine to function as an air-cycle machine in the passive state.

### Power Storage Unit

In some embodiments, the vehicle further comprises at least one rechargeable power storage unit for storing electric power generated by the electric generator and for releasing stored power as electric power to optionally power the gas-turbine in the passive state. Any suitable rechargeable power storage unit may be used, for example power storage assemblies known in the art of all-electric and hybrid ICE electric vehicles, for example a battery pack, a capacitor or a gyroscopic energy storing system. In some embodiments, a power storage unit comprises a battery pack. In such embodiments, electric power received from the power-management unit is stored as chemical energy and is released, when required as electrical power. Any suitable battery chemistry may be used, for example lead-acid, nickel cadmium, nickel metal hydride, lithium ion, lithium ion polymer, zinc air and molten salt chemistry. In some embodiments, a power storage unit comprises a capacitor, for example an ultracapacitor such as is available from Maxwell Technologies (San Diego, Calif., USA) or as described in U.S. Pat. No. 6,787,235 or U.S. Pat. No. 6,602,742. In some embodiments, a power storage unit comprises both a capacitor and a battery pack.

### Absorption Chiller

In some embodiments, the vehicle further comprises an absorption chiller for providing cooling for the vehicle. An absorption chiller is a well-known device that utilizes a heat source to provide cooling. In such embodiments, any suitable absorption chiller is used including NH₃/H₂O, NH₃/H₂/H₂O, LiBr/H₂O, H₂O/H₂SO₄ and air/water/salt absorption chillers. Absorption chillers are commercially available, for example, from Dometic Corporation 2008 (Elkhart, Ind., USA).

In some embodiments, the absorption chiller is configured to be driven by exhaust heat produced by the gas-turbine, for example by providing a valve that optionally directs at least a portion of the exhaust of the gas-turbine to drive the absorption chiller. Exhaust waste heat that would otherwise be released to the atmosphere is captured and used. In some embodiments, the absorption chiller is configured to be driven by exhaust heat produced by the gas-turbine when operated in the active state. In some embodiments, the absorption chiller is configured to be driven by exhaust heat produced by the gas-turbine when operated as an air-cycle machine in the passive state.

In some embodiments, the gas-turbine further comprises a variable chiller diverter valve, configured to regulate the amount of exhaust gas exiting the compressor that is directed to drive the absorption chiller. A variable chiller diverter valve may be physically implemented using any suitable valve or combination of valves. In some embodiments, the variable chiller diverter valve is implemented with one or more valve members held in one more valve bodies.

In some embodiments, a vehicle of the invention is devoid of an electric-powered air-conditioner for providing cooling for the vehicle.

In some embodiments, a vehicle of the invention comprises an electric-powered air-conditioner for providing cooling for the vehicle. In some embodiments, the air-conditioner is operable when the gas-turbine is in the active state. In some embodiments, the air-conditioner is operable when the gas-turbine is in the inactive state.

### Electric Drive Motors

In some embodiments, a vehicle of the invention is provided with at least one electric drive motor to provide the motive force to move the vehicle, similarly to all-electric or hybrid ICE electric vehicles known in the art.

In some embodiments, a vehicle of the invention has a single drive motor functionally associated with one or more wheel axes. In some embodiments, a vehicle of the invention has two drive motors, in some embodiments each functionally associated with a different drive wheel or a different wheel axis. In some embodiments, a vehicle of the invention has more than two drive motors, e.g. three, four or more drive motors.

Similarly to some all-electric or hybrid ICE electric vehicles known in the art, the drive motor or motors of some embodiments of a vehicle of the invention are DC motors, for example, serial-wound DC motors.

Similarly to some all-electric or hybrid ICE electric vehicles known in the art, the drive motor or motors of some embodiments of a vehicle of the invention are AC motors, for example, induction motors or permanent magnet AC motors.

### Regenerative Braking Unit

Some embodiments of a vehicle of the invention also comprise a regenerative braking unit, configured for converting kinetic energy of the vehicle to electrical power. In some embodiments, the electrical power is used to charge the power storage unit and/or to power the at least one driving motors and/or to power an auxiliary load.

### Grid Charging Unit

Some embodiments of a vehicle of the invention also comprise a grid charging unit configured to accept electrical power from an external source (e.g., an electrical power grid, a dedicated vehicle recharging station) to charge the power storage unit. Grid charging assemblies are well-known in the art of all-electric vehicles. In some embodiments, a grid charging unit is configured for conductive coupling to an external power source. In some embodiments, a grid charging unit is configured for inductive coupling to an external power source.

### Power-Management Unit

Some embodiments of a vehicle of the invention include a power-management unit. In general terms, a power-management unit accepts electrical power from power-supplying components of the vehicle and distributes the power to power-using components, as required. In some embodiments, a power distribution is configured to change the characteristics of a current received from a power-supplying component to characteristics of a current required from a power-using component. Characteristics that are typically changed include AC to DC conversion, DC to AC conversion, phase of AC current, frequency of AC current and voltage. A typical power-management unit includes control circuitry, power transmission circuitry, switches, transformers, rectifiers, inverters and control processors. A power-management unit useful for implementing the teachings of the invention is similar to power-management units used in hybrid ICE electric vehicles or known hybrid gas-turbine electric vehicles.

In some embodiments, the main power-using components of a vehicle of the invention are the drive motor or motors. In some embodiments at least one drive motor is a DC motor and the power management unit is configured to provide DC current to the drive motor. In some embodiments at least one drive motor is an AC motor and the power management unit is configured to provide AC current to the drive motor. The amount of power required by the at least one drive motor and provided by the power-management unit is determined primarily by the vehicle operator (driver) and may range from no power when the vehicle is stopped to maximal power for high-speed driving, for climbing hills or transporting heavy cargo. In some embodiments, the amount of power required is communicated to the power-management unit by the vehicle operator using an operator-vehicle interface.

Additional power using-components are the auxiliary loads, especially cooling. The amount of power required by the auxiliary loads, excluding cooling, is relatively minor and constant. The amount of power required by cooling is primarily determined by the operator's preference, the weather and the exact implementation of the invention. Generally, an air conditioner unit, if present and operated, requires a significant amount of power. Generally, power is required to operate the gas-turbine in a passive state as an air-cycle machine. Generally, insignificant or substantially no power is required by an absorption cooler driven by the exhaust of the gas-turbine, whether in the active state or in the passive state. In some embodiments some components of the auxiliary load require DC current and the power management unit is configured to provide DC current to such components. In some embodiments some components of the auxiliary load require AC current and the power management unit is configured to provide AC current to such components.

An important power-supplying component is the electric generator when the gas-turbine is in an active state. In some embodiments, a generator generates DC current and the power management unit is configured to accept DC current from the generator. In some embodiments, a generator generates AC current and the power management unit is configured to accept AC current from the generator.

The power storage unit is both a power-using component and a power-supplying component. In some embodiments, the power-management unit is configured to control the amount of electrical power drawn from the power storage unit, for example to power the at least one drive motor or the auxiliary loads. Generally, the power drawn from a power storage unit is DC current and the power management unit is configured to accept the DC current from the power storage unit. In some embodiments, the power-management unit is configured to control the amount of electric power sent to the power storage unit for storage. Generally, a power storage unit accepts DC current for storage and the power management unit is configured to send DC current to the power storage unit for storage.

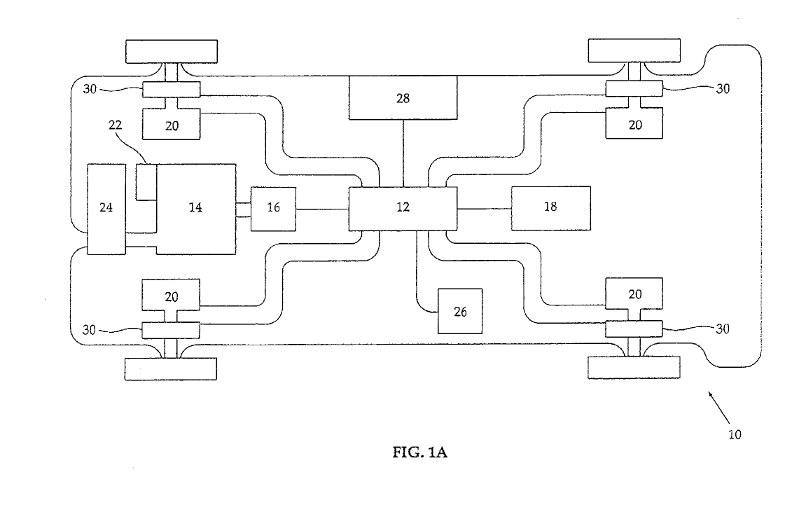

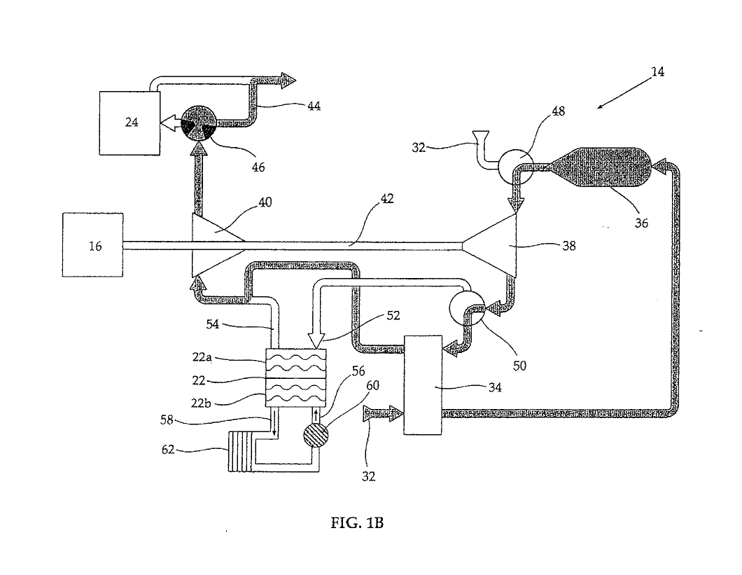

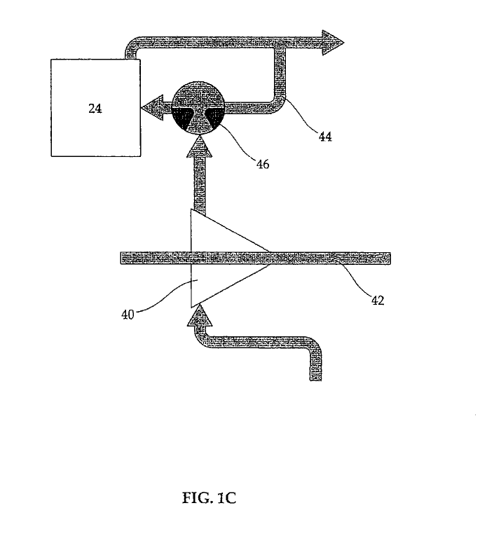

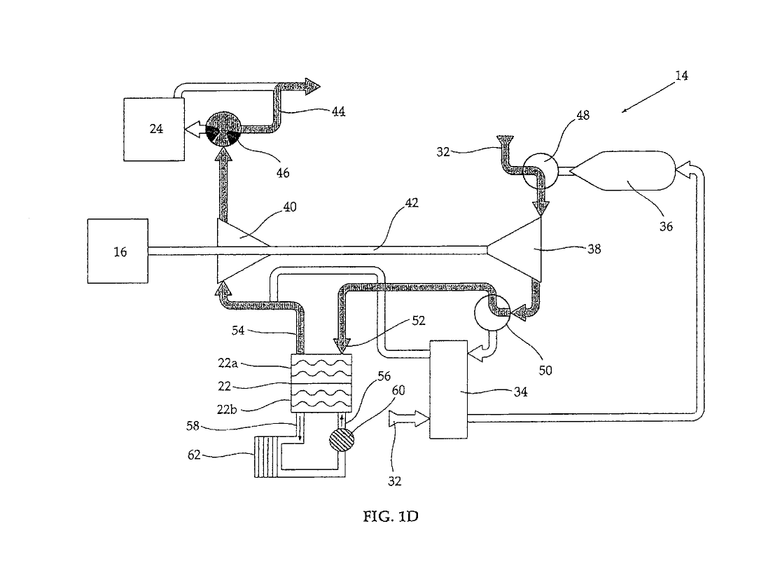

Embodiments of the method of the invention are described hereinbelow with reference to an embodiment of a vehicle of the invention, vehicle 10, schematically depicted in FIGS. 1A, 1B, 1C and 1D.

Vehicle 10, schematically depicted in FIG. 1A, comprises a power-management unit 12, a gas-turbine 14, an electric generator 16 (e.g., an alternator), a power storage unit 18, four electric drive motors 20, an air-cycle machine heat-exchanger 22, an absorption chiller 24, an air conditioner 26, a grid-charging unit 28 and four regenerative braking units 30.

Gas-turbine 14, schematically depicted in FIGS. 1B, 1C and 1D, is a single-spool gas-turbine configured to operate according to an inverse Brayton cycle and includes an air intake 32 (depicted twice in FIG. 1B due to schematic depiction), a rotary regenerator 34, a combustor 36, a turbine 38, a compressor 40, a shaft 42, an exhaust duct 44, a variable chiller diverter valve 46, and an air-cycle machine heat-exchanger diverter valve 50. The various components of gas-turbine 14 are standard components known in the art of microturbines such as commercially available from Capstone Turbine Corporation (Chatsworth, Calif., USA) and described, for example, in “Guide to Microturbines” by Bernard F. Kolanowski, published by The Fairmont Press, Inc., 2004 (ISBN 0881734187, 9780881734188)

Generator 16 is a standard high-speed alternator suitable for use with a vehicular microturbine. Shaft 42 is the rotor of generator 16 so that generator 16 is driven directly by gas-turbine 14. Generator 16 is also configured to function in reverse as a motor, applying a force that rotates shaft 42 and consequently compressor 40 and turbine 38.

Rotary regenerator 34 is a primary heat-exchanger for gas-turbine 14, configured to recover heat from exhaust gas exiting compressor 40 to preheat air entering combustor 36 to increase the thermal efficiency of gas-turbine 14.

Air-cycle machine heat-exchanger 22 is a standard heat-exchanger including two separate conduits: a gas conduit 22a and a cooling fluid conduit 22b. Gas conduit 22a provides fluid communication for gas from turbine 38 through a gas conduit inlet 52, air-cycle machine heat-exchanger 22, a gas conduit outlet 54 to compressor 40. Cooling fluid conduit 22b includes fluid conduit inlet 56, air-cycle machine heat-exchanger 22, fluid conduit outlet 58, pump 60 and passenger compartment cooling element 62. Air-cycle machine heat-exchanger 22 is configured so that gas entering gas conduit inlet 52 and exiting gas conduit outlet 54 accepts heat from fluid in cooling fluid conduit 22b.

Variable chiller diverter valve 46 is a continuously variable valve configured to regulate the amount of exhaust gas exiting from compressor 40 that is directed to enter absorption chiller 24, with excess exhaust gas directed directly to exhaust duct 44.

Absorption chiller 24 is a standard absorption chiller, configured to provide cooling for vehicle 10, especially for the passenger compartment of vehicle 10. Absorption chiller 24 is driven by heat from exhaust gas exiting compressor 40 and directed to absorption chiller 24 by variable chiller diverter valve 46.

Air-cycle machine intake valve 48 is a two-state valve configured to direct gas into turbine 38 either to define fluid communication between air intake 32 and turbine 38 through combustor 36, thereby directing exhaust gas exiting combustor 36 into turbine 38 or to define fluid communication between air intake 32 and turbine 38 bypassing combustor 36, thereby directing ambient air from air intake 32 into turbine 38, bypassing combustor 36 and also rotary regenerator 34.

Air-cycle machine heat-exchanger diverter valve 50 is a two-state valve configured to direct gas exiting from turbine 38, either to enter rotary regenerator 34 or to bypass rotary regenerator 34 and to enter air-cycle machine heat-exchanger 22 through gas conduit inlet 52.

Air conditioner 26 is a standard vehicular gas-evaporation air conditioner.

### Inverse Brayton Gas-Turbine in Active State for Generating Electric Power (FIG. 1B)

Under certain driving conditions, for example in some embodiments during high-speed cruising, gas-turbine 14 is operated in an active state, burning fuel in combustor 36 to release energy that is converted to mechanical energy by expansion through turbine 38, as depicted in FIG. 1B.

Air-cycle machine intake valve 48 is set to direct exhaust gas exiting combustor 36 into turbine 38.

Air-cycle machine heat-exchanger diverter valve 50 is set to direct exhaust gas exiting turbine 38 to pass through the hot stream section of rotary regenerator 34.

Ambient air enters air intake 32, passes through the cold stream section of rotary regenerator 34 to be heated before entering combustor 36. In combustor 36, the heated air is mixed with fuel and the mixture combusted. The hot exhaust gas resulting from the combustion is directed by air-cycle machine intake valve 48 into turbine 38. The hot exhaust gas expands through and rotates turbine 38 (consequently rotating shaft 42 and compressor 40), passes through air-cycle machine heat-exchanger diverter valve 50, through the hot stream section of rotary regenerator 34. The hot exhaust gas is then forced by compressor 40 (driven by shaft 42) into exhaust duct 44 to be ejected to the atmosphere through exhaust duct 44.

One end of shaft 42 constitutes the rotor of generator 16. As a result, rotation of shaft 42 by exhaust gases expanding through turbine 38 causes generator 16 to generate electric power.

The electric power generated by generator 16 is directed to power-management unit 12 which directs the electric power to power drive motors 20 in accordance with the instructions of the vehicle driver and to power auxiliary loads. Excess electric power is directed to charge power storage unit 18. If drive motor 20 requires more power than is generated by generator 16, for example during hill-climbing, power-management unit 12 draws the required electric power from power storage unit 18.

When applicable, for example during braking or downhill driving, electric power generated by regenerative braking unit 30 is directed to power-management unit 12 to power drive motor 20, to power auxiliary loads and/or to charge power storage unit 18.

### Air Conditioner

In some embodiments, cooling is performed in the usual way: power-management unit 12 supplies electric power to air conditioner 26 which functions in the usual way, cooling air, for example, for cooling the passenger compartment. However, as air conditioner 26 requires a significant amount of power, in some embodiments vehicle performance is adversely affected, for example when accelerating for passing, when climbing hills or when transporting heavy cargo. That said, in some embodiments, gas-turbine 14 together with generator 16 has sufficient electric power-generating capacity so that the amount of electric power required to operate air conditioner 26 has no substantial effect on the performance of vehicle 10.

### Absorption Chiller (FIG. 1C)

In some embodiments, instead of or in addition to using air conditioner 26, variable chiller diverter valve 46 is set to direct hot exhaust gas exiting compressor 40 to drive absorption chiller 24, see FIG. 1C. Specifically, variable chiller diverter valve 46 diverts and regulates the amount of hot exhaust gas exiting compressor 40 entering absorption chiller 24 required to produce a desired degree of cooling. Absorption chiller 24 then functions in the usual way, for example, for cooling the passenger compartment of vehicle 10.

### Inverse Brayton Gas-Turbine as Air-Cycle Machine (FIG. 1D)

Under certain driving conditions, for example in some embodiments during urban driving, in stop-and-go driving in a traffic jam, gas-turbine 14 is operated in a passive state where fuel is not combusted in combustor 36. When gas-turbine 14 is in a passive state, electric power for powering drive motors 20 or auxiliary loads is supplied by power-management unit 12, the electric power drawn from power storage unit 18 or generated by regenerative braking unit 30. When gas-turbine 14 is in a passive state, gas-turbine 14 optionally functions as an air-cycle machine to provide cooling for vehicle 10, as detailed below.

### Air Conditioner

In some embodiments, cooling is performed in the usual way: power-management unit 12 supplies electric power to air conditioner 26 which functions in the usual way, cooling air, for example, for cooling the passenger compartment. It is important to note that generally this is undesirable because, as discussed in the introduction, an air conditioning unit such as 26 requires an amount of power that severely limits vehicle performance.

### Air-Cycle Machine (FIG. 1D)

In some embodiments, instead of or in addition to using air conditioner 26, gas-turbine 14 is used as an air-cycle machine to produce cool air, FIG. 1D. Air-cycle machines are known in the art of cooling passenger aircraft.

Pump 60 of air-cycle machine heat-exchanger 22 is activated, cycling fluid into fluid conduit inlet 56, through cooling fluid conduit 22b of air-cycle machine heat-exchanger 22, out through fluid conduit outlet 58, into passenger compartment cooling element 62 and back into pump 60.

Air-cycle machine intake valve 48 is set to direct air entering air intake 32 is into turbine 38 and to bypass combustor 36 and rotary regenerator 34.

Air-cycle machine heat-exchanger diverter valve 50 is set to direct exhaust gas exiting turbine 38 to enter air-cycle machine heat-exchanger 22 and to bypass rotary regenerator 34.

Generator 16 is set to function as a motor using power supplied by power-management unit 12 from power storage unit 18 and/or regenerative braking unit 30 to rotate turbine 38 and compressor 40 through shaft 42.

Compressor 40 draws air from the ducts leading to air-cycle machine heat-exchanger 22, from gas conduit 22a of air-cycle machine heat-exchanger 22, and from the ducts leading to turbine 38, generating low pressure in air-cycle machine heat-exchanger 22 and in the ducts leading to turbine 38. Ambient air enters air intake 32, passes through air-cycle machine intake valve 48 and is drawn through turbine 38. When exiting turbine 38, the air expands and cools. The cool air passes through air-cycle machine heat-exchanger diverter valve 50 to enter gas conduit 22a of air-cycle machine heat-exchanger 22 through gas conduit inlet 52, absorbs heat from cooling fluid in cooling fluid conduit 22b and exits through gas conduit outlet 54 to be drawn into compressor 40.

Cooling fluid in passenger compartment cooling element 62 absorbs heat from the passenger compartment of vehicle 10, transfers the heat to the air in gas conduit 22a of air-cycle machine heat-exchanger 22 and is therefore cooled.

The air draw into compressor 40 is compressed using the turbine expansion energy to supplement the motor power output and consequently heated, passes through variable chiller diverter valve 46 and expelled through exhaust duct 44.

### Absorption Chiller

In some embodiments, for example when greater cooling capacity is required or in order to reduce the amount of power required by generator 16 to drive gas-turbine 14 as an air-cycle machine to achieve a given cooling capacity, variable chiller diverter valve 46 is set to direct hot gas exiting compressor 40 to drive absorption chiller 24, see FIG. 1C. Specifically, variable chiller diverter valve 46 diverts and regulates the amount of hot gas exiting compressor 40 entering absorption chiller 24 required to produce a desired degree of cooling. Absorption chiller 24 then functions in the usual way, for example, for cooling the passenger compartment of vehicle 10. Thus, gas-turbine 14 functioning as an air-cycle machine both cools directly and also produces heat to drive absorption chiller 24.

Vehicle 10 includes absorption chiller 24. In some embodiments, a vehicle of the invention is devoid of an absorption chiller and cooling is performed as described above with the gas-turbine functioning as an air-cycle machine when in a passive state. In some such embodiments, an air conditioner, such as 26, is used together with the gas-turbine operating as an air-cycle machine to provide sufficient cooling. In some such embodiments, when the gas-turbine is an active state, cooling is provided using an air conditioner such as 26.

Vehicle 10 includes air conditioner 26. In some embodiments, a vehicle of the invention is devoid of an air conditioner as the teachings of the inventions render such an air conditioner superfluous. Instead, when the gas-turbine is in an active mode cooling is provided by an absorption chiller and when the gas-turbine is in an active mode cooling is provided by the gas-turbine operating as an air-cycle machine, optionally in combination with the absorption chiller.

In vehicle 10, shaft 42 of gas-turbine 14 is the rotor of generator 16 allowing gas-turbine 14 to power generator 16 directly. In some embodiments, a generator is driven by a gas-turbine in some other way. For example, in some embodiments, a generator is driven by a power spool including a free turbine that is rotated by energetic fluid such as exhaust gas produced by the gas-turbine.

In vehicle 10, when gas-turbine 14 is in a passive state, generator 16 functions as a motor to drive gas-turbine 14 to operate as an air-cycle machine. In some embodiments, a vehicle is provided with a dedicated motor, preferably an electric motor, to drive a gas-turbine to operate as an air-cycle machine in the passive state.

In vehicle 10, when gas-turbine 14 is in a passive state and functions as an air-cycle machine, air-cycle machine intake valve 48 is set to allow ambient air to pass into turbine 38 without entering rotary regenerator 34 (the primary heat-exchanger) or combustor 36. In such a way, suction efficacy is improved and there is a reduced chance that particles from ambient air will damage components, especially the fine channels of rotary regenerator 34. That said, in some embodiments, air passing into a turbine when the gas-turbine is used as an air-cycle machine does not bypass a combustor and/or a primary heat-exchanger.

In vehicle 10, gas-turbine 14 includes rotary regenerator 34 as a primary heat-exchanger to increase thermal efficiency by using heat recovered from exhaust to preheat air entering combustor 36. In some embodiments, a different type of primary heat-exchanger is used instead of a rotary regenerator. In some embodiments, a different type of primary heat-exchanger is used instead of a regenerator, for example a recuperator. In some embodiments, a gas-turbine does not recover heat from exhaust.

Vehicle 10 is an automobile where the teachings of the invention are used primarily to cool the passenger compartment. In some embodiments, a vehicle of the invention is another type of vehicle. In some embodiments, a vehicle of the invention is a commercial vehicle and the teachings of the invention are used to cool a non-passenger cargo compartment, for example for the transport of heat-sensitive cargo such as fish, meat or dairy products.

In vehicle 10, gas-turbine operates according to an inverse Brayton cycle both in the active and the passive state. In some embodiments a vehicle is provided with a gas-turbine that operates according to a Brayton cycle. In some embodiments, a vehicle is provided with a gas-turbine configured to operate according to either a Brayton cycle or an inverse Brayton cycle, for example as described in U.S. Pat. No. 6,526,757.

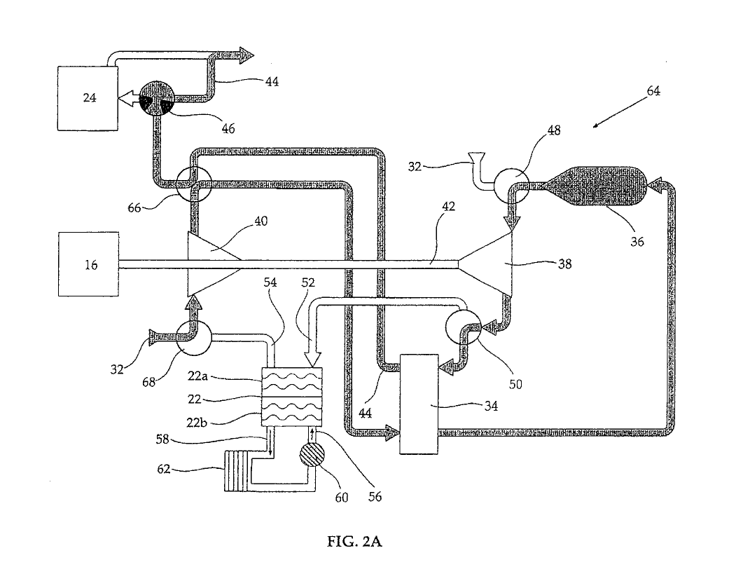

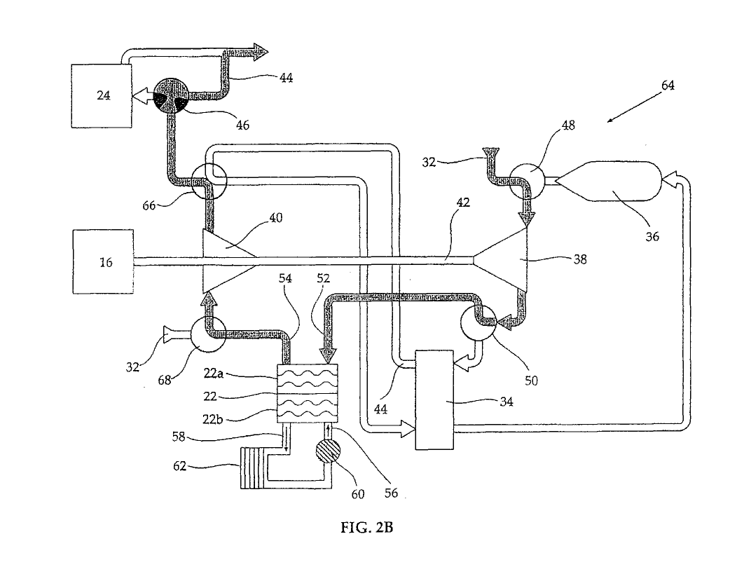

A gas-turbine 64 operating according to a Brayton cycle for implementing the teachings of the invention is depicted in FIG. 2A in an active state for powering an electric generator 16 and in FIG. 2B in a passive state when operating as an air-cycle machine. In general, gas-turbine 64 is operated in the a manner analogous to operation of gas-turbine 14 described above, with some differences as detailed below.

### Brayton Gas-Turbine in Active State for Generating Electric Power (FIG. 2A)

Under certain driving conditions, for example in some embodiments during high-speed cruising, gas-turbine 64 is operated in an active state, burning fuel in combustor 36 to release energy that is converted to mechanical energy by expansion through turbine 38, see FIG. 2A.

Air-cycle machine intake valve 48 is set to direct exhaust gas exiting combustor 36 into turbine 38.

Compressor intake valve 68 is set so that compressor 40 draws ambient air through air intake 32.

Air-cycle machine heat-exchanger diverter valve 50 is set to direct exhaust gas exiting turbine 38 to pass through the hot stream section of rotary regenerator 34.

Compressor outlet valve 66 is set so that air exiting compressor 40 is directed to the cold stream section of rotary regenerator 34 and that exhaust exiting the hot stream section of rotary regenerator 34 is directed to variable chiller diverter valve 46.

Compressor 40 draws ambient air through air intake 32 and forces the air through compressor outlet valve 66, through the cold stream section of rotary regenerator 34 to be heated before entering combustor 36. In combustor 36, the heated air is mixed with fuel and the mixture combusted. The hot exhaust gas of the combustion is directed into turbine 38.

The hot exhaust gas expands through and rotates turbine 38 (consequently rotating shaft 42 and compressor 40), passes through air-cycle machine heat-exchanger diverter valve 50, through the hot stream section of rotary regenerator 34, through compressor outlet valve 66 and into variable chiller diverter valve 46. As discussed above, variable chiller diverter valve 46 directs exhaust to be ejected directly into the atmosphere as depicted in FIG. 2A, or to drive absorption chiller 24.

### Brayton Gas-Turbine as Air-Cycle Machine (FIG. 2B)

Under certain driving conditions, for example in some embodiments during urban driving, in stop-and-go driving in a traffic jam, gas-turbine 64 is operated in a passive state where fuel is not combusted in combustor 36. When gas-turbine 14 is in a passive state, electric power for powering drive motors 20 or auxiliary loads is supplied by power-management unit 12, the electric power drawn from power storage unit 18 or generated by regenerative braking unit 30. When gas-turbine 14 is in a passive state, gas-turbine 14 optionally functions as an air-cycle machine to provide cooling for vehicle 10, see FIG. 2B.

Pump 60 of air-cycle machine heat-exchanger 22 is activated, cycling fluid into fluid conduit inlet 56, through cooling fluid conduit 22b of air-cycle machine heat-exchanger 22, out through fluid conduit outlet 58, into passenger compartment cooling element 62 and back into pump 60.

Air-cycle machine intake valve 48 is set to direct air entering air intake 32 into turbine 38 and to bypass combustor 36 and rotary regenerator 34.

Air-cycle machine heat-exchanger diverter valve 50 is set to direct exhaust gas exiting turbine 38 to enter air-cycle machine heat-exchanger 22 and to bypass rotary regenerator 34.

Compressor intake valve 68 is set so that air exiting gas conduit outlet 54 of air-cycle machine heat-exchanger 22 is directed into compressor 40.

Compressor outlet valve 66 is set to direct air exiting compressor 40 to variable chiller diverter valve 46.

Generator 16 is set to function as a motor using power supplied by power-management unit 12 from power storage unit 18 and/or regenerative braking unit 30 to rotate turbine 38 and compressor 40 through shaft 42.

Compressor 40 draws air from the ducts leading to air-cycle machine heat-exchanger 22, from gas conduit 22a of air-cycle machine heat-exchanger 22, and from the ducts leading to turbine 38, generating low pressure in air-cycle machine heat-exchanger 22 and in the ducts leading to turbine 38. Ambient air enters air intake 32, passes through air-cycle machine intake valve 48 and is drawn through turbine 38. When exiting turbine 38, the air expands and cools. The cool air passes through air-cycle machine heat-exchanger diverter valve 50 to enter gas conduit 22a of air-cycle machine heat-exchanger 22 through gas conduit inlet 52, absorbs heat from cooling fluid in cooling fluid conduit 22b and exits through gas conduit outlet 54 to pass through compressor intake valve 68 to be drawn into compressor 40.

Cooling fluid in passenger compartment cooling element 62 absorbs heat from the passenger compartment of vehicle 10, transfers the heat to the air in gas conduit 22a of air-cycle machine heat-exchanger 22 and is therefore cooled.

The air draw into compressor 40 is compressed and consequently heated, passes through compressor outlet valve 66 and variable chiller diverter valve 46. As discussed above, variable chiller diverter valve 46 directs exhaust to be ejected directly into the atmosphere as depicted in FIG. 2A, or to drive absorption chiller 24.

In the exemplary embodiments described above with reference to the Figures, the teachings of the invention are implemented primarily to cool the passenger compartment of a vehicle.

As understood from the above, in some embodiments, the teachings of the invention are implemented, in some embodiments additionally, to cool a non-passenger cargo compartment. For example, in some embodiments, a vehicle is configured so that at least part of the provided cooling provided is directed to a non-passenger cargo compartment, for example, passenger compartment cooling element 62 described above becomes cargo compartment cooling element 62.

As understood from the above, in some embodiments, the teachings of the invention are implemented, in some embodiments additionally, to cool a power storage unit, such as a battery, of the vehicle. For example, in some embodiments, a vehicle is configured so that at least part of the cooling provided is directed to a power storage unit, for example, passenger compartment cooling element 62 described above becomes power storage unit cooling element 62.

### EXAMPLES

Reference is now made to the following examples, which together with the above descriptions illustrate some embodiments of the invention in a non limiting fashion. The calculations were performed with the help of “GasTurb 11” by Dr. Joachim Kurzke (Germany, www.gasturb.de) using representative values for a gas-turbine operating according to an inverse Brayton cycle.

Cooling Using a Gas-Turbine as an Air-Cycle Machine

### Input Conditions:

Air flow=0.06 kg/sec

Turbine expansion ratio=1.55

Compressor pressure ratio=1.566

Ambient Temperature=30° C.

Ambient Pressure=101.35 kPa

Ambient humidity=60%

Turbine efficiency=85%

Compressor efficiency=77%

Heat-exchanger efficiency=90%

Heat-capacity factor of air (Cₚ)=1.005 kj/(kg K)

### Calculated Performance:

Enthalpy drop of turbine=30.5 kJ/kg

Enthalpy rise of compressor=53.5 kJ/kg

Turbine outlet temperature=0° C.

Turbine outlet pressure=64.7 kPa

Air-cycle machine heat-exchanger outlet temperature=3° C.

Air-cycle machine heat-exchanger inlet temperature=30° C.

Compressor outlet temperature=80.3° C.

Compressor outlet pressure=102 kPa

Compressor inlet temperature=27° C.

Compressor inlet pressure=62.7 kPa

Motor power requirement=0.050 kW
(based on a hot pressure drop of 1 kPa, an air flow of 0.06 kg/sec and Motor electric efficiency of 80%)

Alternator electric efficiency=0.95

electric power requirement (cooling+motor power)=(53.5−30.5)*0.06/0.95=1.45 kW+0.05 kW=1.5 kW

Cooling Capacity=1.005*(30−3)*0.06=1.63 kW

$$\begin{matrix}Coefficient of Performance ( COP ) = cooling capacity / \\ power requirement \\ = 1.63 / 1.5 \\ = 1.09\end{matrix}$$

Cooling Using a Typical Gas-Turbine as an Air-Cycle Machine Together with an Absorption Chiller

### Input Conditions:

Temperature of the cooled absorption chiller generator=24° C.

Compressor inlet temperature=80.3° C.

Absorption chiller heat-exchanger efficiency=90%

### Calculated Performance:

Cooling capacity of absorption chiller=(80.3−24)*0.06*0.9=3.04 kW

Combined cooling capacity (chiller+air-cycle machine)=3.04 kW+1.63 kW=4.67 kW

$$\begin{matrix}Coefficient of Performance ( COP ) = cooling capacity / \\ power requirement \\ = 4.67 / 1.5 \\ = 3.11\end{matrix}$$

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

Section headings are used herein to ease understanding of the specification and should not be construed as necessarily limiting.

1. A gas-turbine hybrid electric vehicle, comprising:
a) a generator for generating electric power; and
b) a gas-turbine, including an air intake, a combustor, a compressor and a turbine, functionally associated with said generator and configured to operate in at least two states:
i. an active state wherein said gas-turbine powers said generator to generate electric power; and
ii. a passive state where said gas-turbine functions as an air-cycle machine to provide cooling for the vehicle.

2. The vehicle of claim 1, wherein configuration of said gas-turbine to operate in said active state and in said passive state includes a valve.

3. The vehicle of claim 2, further comprising an air-cycle machine intake valve and wherein:
said air-cycle machine intake valve is configured to direct exhaust from said combustor to said turbine in said active state; and
said air-cycle machine intake valve is configured to direct air from said air intake to said turbine while bypassing said combustor in said passive state.

4. The vehicle of claim 1, wherein said gas-turbine comprises a primary heat-exchanger to recover heat from exhaust gas exiting said compressor to preheat air entering said combustor in said active state.

5. The vehicle of claim 4, further comprising an air-cycle machine heat-exchanger, configured to cool a cooling fluid when said gas-turbine operates as an air-cycle machine in said passive state, and an air-cycle machine heat-exchanger diverter valve, wherein:
said air-cycle machine heat-exchanger diverter valve is configured to direct gas exiting said turbine to pass through said primary heat-exchanger in said active state; and
said air-cycle machine heat-exchanger diverter valve is configured to direct gas exiting said turbine to bypass said primary heat-exchanger and to pass through said air-cycle machine heat-exchanger in said passive state.

6. The vehicle of claim 1, further comprising an air-cycle machine motor, configured for driving said gas-turbine to operate as an air-cycle machine in said passive state.

7. The vehicle of claim 1, wherein said generator is configured to drive said gas-turbine to function as an air-cycle machine in said passive state.

8. The vehicle of claim 1, further comprising at least one rechargeable power storage unit for storing electric power generated by said electric generator and for releasing stored power as electric power to optionally power said gas-turbine in said passive state.

9. The vehicle of claim 1, further comprising an absorption chiller for providing cooling for the vehicle.

10. The vehicle of claim 9, wherein said absorption chiller is configured to be driven by exhaust heat produced by said gas-turbine.

11. The vehicle of claim 10, wherein said absorption chiller is configured to be driven by exhaust heat produced by said gas-turbine when operated in said active state.

12. The vehicle of claim 10, wherein said absorption chiller is configured to be driven by exhaust heat produced by said gas-turbine when operated as an air-cycle machine in said passive state.

13. The vehicle of claim 10, further comprising a variable chiller diverter valve, configured to regulate the amount of exhaust gas exiting said compressor that is directed to drive said absorption chiller.

14. The vehicle of claim 1, devoid of an electric-powered air-conditioner for providing cooling for the vehicle.

15. The vehicle of claim 1, further comprising an electric-powered air-conditioner for providing cooling for the vehicle.

16. The vehicle of claim 15, wherein said air-conditioner is operable when said gas-turbine is in said active state.

17. The vehicle of claim 15, wherein said air-conditioner is operable when said gas-turbine is in said inactive state.

18. A method of operating a hybrid gas-turbine electric vehicle, comprising:
a) in a first operation mode, providing electric power to an electric drive motor of the vehicle with electric power generated by an electric generator powered by a gas-turbine operating in an active state; and
b) switching to a second operation mode, wherein said gas-turbine is in a passive state operating as an air-cycle machine to provide cooling for the vehicle.

19. The method of claim 18, in said first operation mode, directing exhaust from said gas-turbine to drive an absorption chiller to provide cooling for the vehicle.

20. The method of claim 18, in said second operation mode, directing exhaust from said gas-turbine to drive an absorption chiller to provide cooling for the vehicle.

21. The method of claim 18, further comprising, in said first operation mode, operating an air-conditioner to provide cooling for the vehicle.

22. The method of claim 18, further comprising, in said second operation mode, operating an air-conditioner to provide cooling for the vehicle.

23. The method of claim 18, wherein said cooling is used to cool a passenger compartment of the vehicle.

24. The method of claim 18, wherein said cooling is used to cool a non-passenger cargo compartment of the vehicle.

25. The method of claim 18, wherein said cooling is used to cool a power storage unit of the vehicle.
